(19) United States
(12) Patent Application Publication
(10) Pub. No.: US 2008/0313668 A1
(43) Pub. Date: Dec. 18, 2008

(54) ABBREVIATED ADVERTISEMENT SUBSTITUTION DURING FAST FORWARD OR SKIP COMMAND

(76) Inventor: Andrew G. Setos, Pacific Palisades, CA (US)

Correspondence Address: Cantor Colburn LLP - Fox Entertainment Group, 20 Church Street, 22nd Floor, Hartford, CT, 06103, US

(21) Appl. No.: 12/137,848

(22) Filed: Jun. 12, 2008

Related U.S. Application Data
(60) Provisional application No. 60/943,712, filed on Jun. 13, 2007.

(51) Int. Cl. H04N 7/10

(52) U.S. Cl. 725/32

(57) ABSTRACT

A system and method for substituting a shorter message, comprising sound, picture or both, for a longer advertisement or the like. The message may to communicate to the viewer that there is a message of a particular type being passed by or may simply provide a shorter message. The shorter message may be an abbreviated version of the longer message, or may be a completely different shorter message.

### CROSS REFERENCE TO RELATED APPLICATIONS

The present application claims priority to U.S. Provisional Patent Application Ser. No. 60/943,712, filed Jun. 13, 2007, the entire contents of which are specifically incorporated by reference herein.

### BACKGROUND

A common and pervasive problem for providers of advertisements, public service announcements, commercial announcements, and the like, for recorded or DVR replay of programming is the tendency of viewers to fast forward or skip advertisements.

For example, viewers may fast forward through commercial and promotional messages that they are not interested in, however the speed of fast forward can sometimes obfuscate the message itself, since the sound is obliterated and the picture is distorted, or at the least, speed up. This rapidly causes message recognition to be minimal. Therefore even messages of interest would be passed by.

It is detrimental to lose advertising effectiveness of a captive audience when observers fast-forward or find ways to delete the commercials. What is needed in the art are effective mechanisms for preventing such broadcast segments from losing value.

### SUMMARY

The above-described and other problems and deficiencies of the prior art are overcome and alleviated by the presently described system and method for substitution of an advertisement or the like (essentially any filler programming between break segments of the primary program) with an abbreviated advertisement or the like.

### BRIEF DESCRIPTION OF THE DRAWINGS

Referring now to the drawings, wherein like elements are numbered alike in the following FIGURE:

FIG. 1 is an exemplary flowchart illustrating storage of broadcast content along with substitution of advertisements or the like with shorter messages.

### DETAILED DESCRIPTION OF EXEMPLARY EMBODIMENTS

Reference will now be made in detail to exemplary embodiments, examples of which are illustrated by the accompanying drawing.

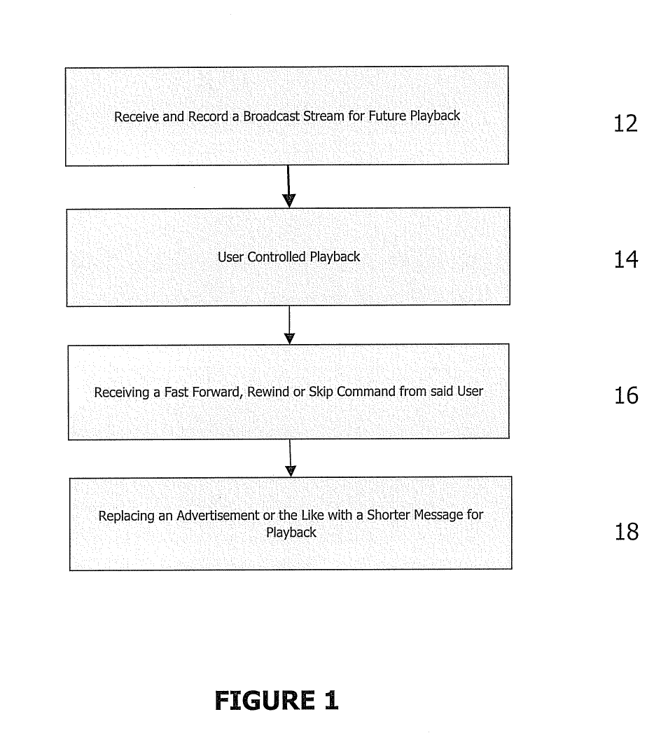

Referring now to FIG. 1, an exemplary method for substitution of an advertisement or the like (essentially any filler programming between break segments of the primary program) with an abbreviated advertisement or the like is illustrated. The illustrated exemplary embodiment relates to receiving a broadcast stream and recording (storing) of at least a portion of such stream for future playback (see box 12). Upon user playback 14, and specifically upon receipt by the appliance (i.e., the playback device or an associated device) of a fast forward, rewind or skip command 16, the appliance replaces an advertisement or the like with a shorter message for playback (see box 18).

In an exemplary embodiment, the present method substitutes a short message, comprising sound, picture or both for a longer advertisement or the like. The message may to communicate to the viewer that there is a message of a particular type being passed by or may simply provide a shorter message. The shorter message may be an abbreviated version of the longer message, or may be a completely different shorter message.

This substitute message may be stored in an appliance, e.g., a DVR, ahead of or contemporaneous with streaming of the longer form message. For example, metadata may be attached to both the short version and the long form version, and when the appliance is asked to fast-forward through a message, the corresponding short form would be played instead.

In exemplary embodiments, the choice of fast forward speed and the length of the short version may be synchronized so that the viewer has the time to absorb the short message. This may be done by having the short form message metadata inform the appliance how long it is in order that the appliance rejoin the original recording 30 seconds later when the short form is complete with no apparent delay. In other exemplary embodiments, rewind function may be set to always show the long form version of the message.

In exemplary embodiments, the message may include indications verifying a fast-forward, skip or rewind function during the substitution of the shorter message for the longer message.

In an exemplary embodiment, a file may be sent once or multiple times with updated information including the short form messages. Such file may also be sent, downloaded or broadcast before, during or after the initial broadcast. Storage of the file need not be local, but may also be at a central server in a client/server environment or at a distributed server including a server within the consumer's premises.

Either the file, if it is used, and/or the broadcast, if they are to be stored locally, may be placed on any convenient device, including a hard drive or flash drive (e.g., on a computer or set top box), a digital video recorder (DVR) a VCR, a DVD media or the like. Likewise short form messages for replacing the longer form messages may be stored on the same and/or may be pulled periodically from one or more subsequent broadcast streams, or downloaded up and until the device calls for replacement of a segment.

Exemplary types of messages include, but are not limited to (by example only and without limitation): openings and endings of scripted programs; public service announcements; promotional announcements; commercial announcements; weather advisories; and traffic advisories, among others.

The short form messages may also be targeted to an observer or a household based on behavior, demographics, preferences or the like.

It will be apparent to those skilled in the art that, while exemplary embodiments have been shown and described, various modifications and variations can be made to the time dependent broadcast segment replacement method disclosed herein without departing from the spirit or scope of the invention. Accordingly, it is to be understood that the various embodiments have been described by way of illustration and not limitation.

What is claimed is:

1. A method for substitution of an advertisement or the like, comprising:
receiving and storing a media stream on a storage device for future playback;
upon user controlled playback, said device receiving a fast forward, rewind or skip command from said user; and
replacing an advertisement or the like with a shorter message for playback.

2. A method in accordance with claim 1, wherein said media stream is a broadcast media stream.

3. A method in accordance with claim 1, wherein the advertisement is configured to play between segments of said media stream.

4. A method in accordance with claim 3, wherein said shorter message is substituted between said segments for said advertisement upon receipt by the device of a fast forward, rewind or skip command such that the time between playback of said segments is correspondingly shortened.

5. A method in accordance with claim 1, wherein said shorter message is an advertisement.

6. A method in accordance with claim 1, wherein said device is a television set-top box, a television receiver, or a digital video recording device.

7. A method in accordance with claim 1, wherein said shorter message indicates the nature or type of advertisement that is being replaced.

8. A method in accordance with claim 1, wherein said shorter message is an abbreviated version or the advertisement that is being replaced.

9. A method in accordance with claim 1, wherein the media stream includes predetermined advertisements and shorter messages for alternative selection dependent upon whether a fast forward, skip or rewind command is received by the device.

10. A method in accordance with claim 9, wherein the advertisements and shorter messages are identified and selected by the device dependent upon metadata attached to the advertisements and shorter messages.

11. A method in accordance with claim 10, wherein said device determines the relative lengths of said advertisements and shorter messages according to said metadata, and wherein playback timing of the media segments is determined according to said lengths.

12. A method in accordance with claim 1, wherein said shorter message is substituted for said advertisement only upon receipt of a fast forward or skip command.

13. A method in accordance with claim 1, wherein a media prompt is given to the user during said substituted shorter message verifying that a fast forward, skip or rewind command has been received and is being performed.

14. A method in accordance with claim 1, wherein said advertisement or shorter message is stored on said device, and wherein one or more updated advertisements or shorter messages are uploaded to said device as a replacement for the now older or undesired advertisement or shorter message.

15. A method in accordance with claim 14, wherein said device is periodically updated with new advertisements or shorter messages.

16. A method in accordance with claim 1, wherein said advertisement or shorter message is stored on a media distributing server, and wherein selection of said advertisement or shorter message is dependent upon the commands received by the device from the user.

17. A method in accordance with claim 16, wherein said advertisement or shorter message is periodically updated with new advertisements or shorter messages.

18. A method in accordance with claim 1, wherein said advertisement or shorter message is targeted to the user based on user behavior, demographics or preferences.

19. A system for media playback, including substitution of an advertisement or the like, comprising:
a storage device for receiving and storing one or more media streams for future playback;
a user interface, configured to provide controls to the user for playback, fast forward, skip and/or rewind functions, wherein
upon user controlled playback, said user interface receiving a fast forward, rewind or skip command from said user prompts replacing an advertisement or the like with a shorter message for playback.

20. A system in accordance with claim 1, wherein said media stream is a broadcast media stream.

21. A system in accordance with claim 1, wherein the advertisement is configured to play between segments of said media stream.

22. A system in accordance with claim 21, wherein said shorter message is substituted between said segments for said advertisement upon receipt by the device of a fast forward, rewind or skip command such that the time between playback of said segments is correspondingly shortened.

23. A system in accordance with claim 1, wherein said shorter message is an advertisement.

24. A system in accordance with claim 1, wherein said user interface is a television set-top box, a television receiver, or a digital video recording device.

25. A system in accordance with claim 1, wherein said device is a television set-top box, a television receiver, or a digital video recording device.
